(19) United States
(12) Patent Application Publication
(10) Pub. No.: US 2026/0119813 A1
(43) Pub. Date: Apr. 30, 2026

(54) SCREEN CAPTURE INTEGRATION FOR INCIDENT REPORTING

(71) Applicant: Ivanti, Inc., South Jordan, UT (US)

(72) Inventor: Satish Prabhakar Vanahalli, Bengaluru (IN)

(73) Assignee: Ivanti, Inc., South Jordan, UT (US)

(21) Appl. No.: 19/263,433

(22) Filed: Jul. 8, 2025

(30) Foreign Application Priority Data
Oct. 26, 2024 (IN) 202411081751

(51) Int. Cl. G06F 40/40; G06F 9/451; G06F 40/166; G06Q 10/0631; G06V 30/19

(52) U.S. Cl. CPC G06F 40/40; G06F 9/451; G06F 40/166; G06Q 10/06315; G06V 30/19

(57) ABSTRACT

An embodiment includes a method of creating an incident report for an incident in an incident workspace. The method includes obtaining incident data including one or both of screenshots and screen recordings of the incident. The one or both of screenshots and screen recordings are obtained using screen capture feature integrated in the incident workspace. The method includes analyzing the incident data based on the one or both of screenshots and screen recordings to identify one or more incidental features. The method includes generating a reconstructed incident corresponding to the incident based on the one or more incidental features. The method includes performing diagnostics of the incident based on the reconstructed incident to identify one or more potential causes and one or more potential solutions for the incident. The method includes evaluating the one or more potential solutions.

### CROSS-REFERENCE TO RELATED APPLICATION

This application claims the benefit of and priority to Indian Provisional Application No. 202411081751, filed Oct. 26, 2024, the disclosure of which is incorporated herein by reference in its entirety.

### FIELD

The present disclosure relates to information technology service management (ITSM) networks, and more particularly to systems and methods of incident management based on reconstructed incidents.

### BACKGROUND

Information technology service management (ITSM) systems are implemented in managed networks to enable control of managed devices. ITSM systems may enable a centralized incident response of managed devices. Users of the managed devices may raise and/or report incidents or issues related to the managed devices or the ITSM system. The reported incidents may help the ITSM systems and organizations to identify and address problems such that the managed devices remain secure, functional, and/or compliant with the corporate policies. Some traditional methods of incident reporting include reporting the incidents to the management system through ITSM engine or application, help desk portal, email and/or phone. The user generally provides device information, description of the incident, time and date of the incident, user information, or some combination thereof.

Such traditional reporting systems pose challenges with respect to evaluation and mitigation of incidents as the incidents may be difficult to understand. For instance, the description of the incident may be insufficient and/or incorrect to fully understand the incident. Additionally, different users may have different formats of describing incidents which may be difficult for the system to understand. In some instances, additional information such as screenshots may be provided by the user. However, such processes present another set of issues related to formatting, large file sizes, requirement of additional tools (e.g., screen capture tools), among others.

Accordingly, there is a need in the field of ITSM systems that provides incident reporting platform with an integrated screen recording tool. The subject matter claimed herein is not limited to embodiments that solve any disadvantages or that operate only in environments such as those described. Rather, this background is only provided to illustrate one example technology area where some embodiments described herein may be practiced.

### SUMMARY

According to an aspect of an embodiment includes a method of incident reporting and analysis. The method may include creating an incident report for an incident in an incident workspace. The method may include obtaining incident data including one or both of screenshots and screen recordings of the incident, the one or both of screenshots and screen recordings obtained using screen capture. The incident data may be obtained from a user through a user interface (UI). The incident data may include basic incident information provided by a user, such as incident title, incident time, initial status, affected user, and/or affected components. The method may include analyzing the incident data based on the screenshots to identify one or more incidental features. The analysis of the incident data may include extracting text data from the screenshots using optical character recognition and analyzing the text data and the one or more screenshots or screen recordings using an artificial intelligence (AI) model. The AI model may be a large language model (LLM) that may analyze the text data such as generating a summary of the text data. The AI model may capture user device information from the text data, in which the user device information includes one or more of device or user identifier information relative to a network, device type and component capabilities, role assignment of a user, policies applicable to the device or user, products sitting on the device and status of products, and/or geographic location. The method includes generating a reconstructed incident corresponding to the incident based on the one or more incidental features. Diagnostics of the incident may be performed based on the reconstructed incident to identify one or more potential causes and one or more solutions for the incident. The method may further include evaluating the one or more potential solutions. The method may also include generating a summary of the incident report. The summary may include one or more of: type of incident, possible causes of the incident, possible solutions to the incident, a summary of the incident, and the one or both of screenshots and screen recordings. The method may also include storing the one or more screenshots or screen recordings in a cloud-based storage; generating a unique uniform resource locator (URL) corresponding to the one or more screenshots or screen recordings; and associating the URL with the incident report.

An additional aspect of an embodiment includes a non-transitory computer-readable medium having encoded therein programming code executable by one or more processors to perform or control performance at least a portion of the method described above.

Yet another aspect of an embodiment includes a computer device. The computer device may include one or more processors and a non-transitory computer-readable medium. The non-transitory computer-readable medium has encoded therein programming code executable by the one or more processors to perform or control performance of one or more of the operations of the methods described above.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1 depicts a block diagram of an example operating environment in which some embodiments described in the present disclosure may be implemented;

FIG. 2 depicts a block diagram of an incident reporting and management process that may be implemented in the operating environment of FIG. 1;

FIG. 3 illustrates a flowchart of a process for incident reporting and management process that may be implemented in the operating environment of FIG. 1;

FIG. 4 illustrates an example computer system configured for data collection optimization; and

FIG. 5 is a flow chart of an example method of incident reporting and management;

all according to at least one embodiment described in the present disclosure.

### DESCRIPTION OF SOME EXAMPLE EMBODIMENTS

The embodiments described in this disclosure are related to information technology service management (ITSM) networks. Some embodiments are directed to system and methods of incident reporting and management in the ITSM networks. For instance, in some embodiments, an incident workspace platform may be provided, in which an incident report may be created. For instance, a request to create an incident or an issue from an endpoint user may be obtained, and an incident report may be created. In some embodiments, incident data may be obtained from the endpoint user. In some embodiments, the incident data may include at least one or more screenshots and/or screen recordings of the incident. In some embodiments, the one or more screenshots and/or the screen recordings may be obtained using screen capture feature of the incident workspace platform. For example, the incident workspace may allow the endpoint user to generate and submit screen captures and/or recordings via the screen capture feature integrated onto the incident workspace. The incident data may be analyzed based on the screenshots or screen recordings to identify one or more incidental features. Based on the one or more incidental features, the incident may be reconstructed. Incident diagnostics may be performed based on the reconstructed incident to identify one or more potential causes and one or more potential solutions to the incident. In some embodiments, the one or more potential solutions may be evaluated.

These and other embodiments are described with reference to the appended Figures in which like item number indicates like function and structure unless described otherwise. The configurations of the present systems and methods, as generally described and illustrated in the Figures herein, may be arranged and designed in different configurations. Thus, the following detailed description of the Figures, is not intended to limit the scope of the systems and methods, as claimed, but is merely representative of example configurations of the systems and methods.

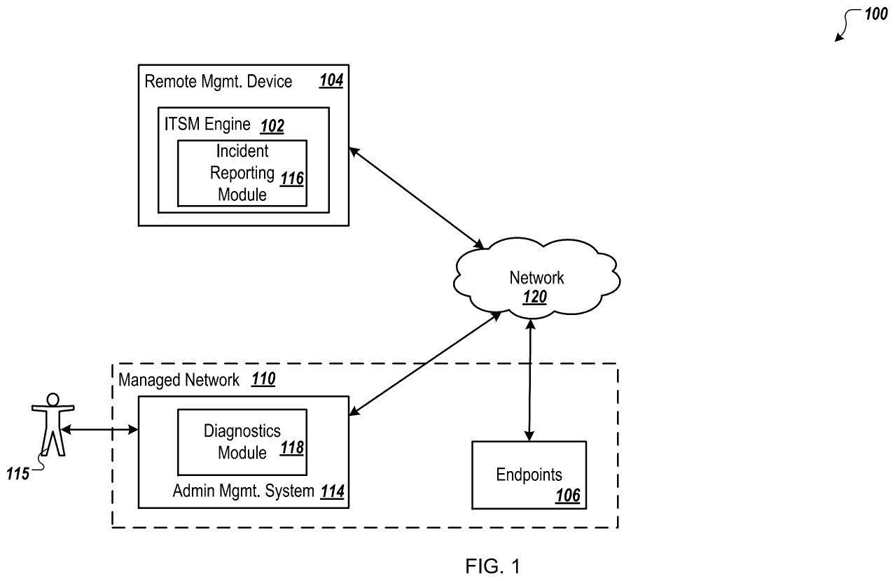

FIG. 1 depicts an example operating environment 100 in which some embodiments may be implemented. The operating environment 100 may be configured for incident reporting and management. For instance, the operating environment 100 may include one or more endpoints 106 (e.g., devices managed by the ITSM) that may experience issues or incidents that may affect performance of the endpoints 106. The issues or incidents may include any events that may affect compliance, safety, and/or performance of the endpoints 106. The endpoints 106 or the users of the endpoints 106 may report such incidents to admin management device 114 such that the incidents may be resolved. In some embodiments, the endpoints 106 may report the incidents to the admin management device 114 via the ITSM engine 102. Particularly, the ITSM engine 102 may include an incident reporting module 116 configured for incident reporting. The incident reporting module 116 may obtain incident data including one or more screenshots or screen recordings.

In some embodiments, the screen recordings and/or the screenshots may be obtained using screen capture. The incident data may be analyzed to determine one or more incidental features. The incidental features may be used to reconstruct the incident. Diagnostics may be performed on the incident using the reconstructed incident to identify one or more potential causes and one or more potential solutions for the incident.

Conventional ITSM systems may have incident reporting processes. Such conventional ITSM systems generally provide a platform or a helpdesk in which users may submit a ticket or an incident report. The helpdesk may be integrated within the ITSM system or the ITSM engine. The incident report generally includes user's description of the incident including device or user information, time and date of the incident, description of the issue, and/or severity level. The reported incident may be analyzed to classify and prioritize the incident. Based on the description of the incident, the incident may be analyzed to determine one or more solutions. However, such conventional ITSM systems and incident reporting processes are limited in the scope of the information associated with the incident that may be obtained. For example, the ITSM systems can only obtain what the user provides. Such descriptions may vary with respect to the terms used, amount of information, and/or level of details depending on different users. Accordingly, these conventional ITSM systems may suffer from incorrect and/or incomplete understanding and/or analysis of the incidents.

Embodiments of the present disclosure provide a technical improvement to conventional ITSM systems. Specifically, embodiments of the present disclosure use an incident reporting system with an integrated screen capture feature, which is represented in FIG. 1 by incident reporting module 116 combined with a diagnostics module 118. In some embodiments, the incident reporting module 116 may be included as a part of the ITSM engine 102. In other embodiments, the incident reporting module may be separate from the ITSM engine 102. The incident reporting module 116 may be configured to provide an incident reporting platform or a helpdesk for the endpoints 106. For example, the incident reporting module 116 may provide a system in which the users may submit a ticket or a report for an incident. The incident reporting module 116 may obtain incident information from the endpoints 106 to generate a reconstructed version of the incident. The reconstructed incident may be analyzed using the diagnostics module 118.

Accordingly, examples of the present disclosure are directed to a computer-centric problem and are implemented and are implemented in a computer-centric environment. For instance, the examples of the present disclosure redirected to ITSM systems in the managed network 110. Computing processes occurring in the operating environment 100 include communication of incidents from users, analysis of the incidents, and communication of solutions to the endpoints 106. Communications during the processes described in this present disclosure involve the communication of data in electronic and optical forms via a network 120 and also involve the electrical and optical interpretation of the data and information.

The operating environment 100 may include the managed network 110 and a remote management device 104. The managed network 110 may include admin management device 114 and the endpoints 106. The components of the operating environment 100 are configured to communicate data and information via the network 120 to perform reporting and analysis of incidents as described in the present disclosure. Each of these components are introduced below.

The network 120 may include any communication network configured for communication of signals between the components (e.g., 104, 112, 108, 114, and 106) of the operating environment 100. The network 120 may be wired or wireless. The network 120 may have configurations including a star configuration, a token ring configuration, or another suitable configuration. Furthermore, the network 120 may include a local area network (LAN), a wide area network (WAN) (e.g., the Internet), and/or other interconnected data paths across which multiple devices may communicate. In some examples, the network 120 may include a peer-to-peer network. The network 120 may also be coupled to or include portions of a telecommunications network that may enable communication of data in a variety of different communication protocols.

In some examples, the network 120 includes or is configured to include a BLUETOOTH® communication network, a Z-Wave® communication network, an Insteon® communication network, an EnOcean® communication network, a Wi-Fi communication network, a ZigBee communication network, a representative state transfer application protocol interface (REST API) communication network, an extensible messaging and presence protocol (XMPP) communication network, a cellular communications network, any similar communication networks, or any combination thereof for sending and receiving data. The data communicated in the network 120 may include data communicated via short messaging service (SMS), multimedia messaging service (MMS), hypertext transfer protocol (HTTP), direct data connection, wireless application protocol (WAP), or any other protocol that may be implemented in the components of the operating environment 100.

The managed network 110 includes the admin management device 114 and the endpoints 106. The managed network 110 is implemented to enable management of the endpoints 106 by the remote management device 104. To implement the managed network 110, the endpoints 106 may be enrolled. After the endpoints 106 are enrolled, ongoing management of the endpoints 106 may be implemented by the remote management device 104. The ongoing management may include overseeing and dictating at least a part of the operations at the endpoints 106 as well as dictate or control policies such as application policies, security policies, communication policies, etc. at the endpoints 106 as described in the present disclosure. The managed network 110 may be associated with an enterprise, a portion of an enterprise, a government entity, or another entity or set of devices.

The endpoints 106 may include hardware-based computer systems that are configured to communicate with the other components of the operating environment 100 via the network 120. The endpoints 106 may include any computer device that may be managed by the remote management device 104 and/or have been enrolled in a managed network 110. Generally, the endpoints 106 include devices that are operated by the personnel and systems of an enterprise or store data of the enterprise. The endpoints 106 might include workstations of an enterprise, servers, data storage systems, printers, telephones, internet of things (IOT) devices, smart watches, sensors, automobiles, battery charging devices, scanner devices, etc. The endpoints 106 may also include virtual machines, which may include a portion of a single processing unit or one or more portions of multiple processing units, which may be included in multiple machines.

The admin management device 114 may include a hardware-based computer system that is configured to communicate with the other components of the operating environment 100 via the network 120. The admin management device 114 is configured to assist in the provision of management service in the managed network 110. The admin management device 114 may be associated with an administrator 115. The administrator 115 may be an individual, a set of individuals, or a system that interfaces with the admin management device 114. In some examples, the administrator 115 may provide input to the admin management device 114. The input provided by the administrator 115 may form the basis of some computing processes performed by the admin management device 114 and the remote management device 104.

In some embodiments, the admin management device 114 is one of the endpoints 106. In some embodiments, the admin management device 114 may be omitted, and the administrator 115 may use one of the endpoints 106 to interface with the management device 104 remotely.

The admin management device 114 may include a hardware-based computer system that is configured to communicate with the other components of the operating environment 100 via the network 120. The admin management device 114 is configured to assist in the provision of management service in the managed network 110. The admin management device 114 may be associated with an administrator 115. The administrator 115 may be an individual, a set of individuals, or a system that interfaces with the admin management device 114. In some examples, the administrator 115 may provide input to the admin management device 114. The input provided by the administrator 115 may form the basis of some computing processes performed by the admin management device 114 and the remote management device 104.

The remote management device 104 may include a hardware-based computer system that is configured to communicate with the other components of the operating environment 100 via the network 120. In some embodiments, the remote management device 104 may be a single server, a set of servers, a virtual device, or a virtual server in a cloud-base network of servers. In these and other embodiments, one or more of the components of the remote management device 104 may be spread over two or more cores, which may be virtualized across multiple physical machines.

The remote management device 104 may be associated with an administrator (e.g., the administrator 115). The administrator may be an individual, a set of individuals, or a system that interfaces with the remote management device 104. In some embodiments, the administrator may provide input to the remote management device 104. The input provided by the administrator may form the basis of some computing processes and operations performed by the remote management device 104.

The remote management device 104 may be configured for service management of the endpoints 106 in the managed network 110. In general, service management of the endpoints 106 may include help desk and technical ticketing. In the managed network 110 other management services may be implemented such as patch or update management, application management, asset management, vulnerability detection, other management services, or combinations thereof.

The remote management device 104 may include the ITSM engine 102 and the incident reporting module 116. The ITSM engine 102 may be configured to facilitate the incident reporting process for the endpoints 106. For example, in some embodiments, the incident reporting module 116 may be part of the ITSM engine 102. For instance, the ITSM engine 102 may host the incident reporting module 116 for the users of the endpoints 106. In some embodiments, the incident reporting module 116 may be separate from the ITSM engine 102. For instance, the incident reporting module 116 may be implemented as part of the remote management device 104 but not the ITSM engine 102.

The incident reporting module 116 may be configured to provide the users of the endpoints 106 with a platform in which the users may report various issues and/or incidents. For example, the incident reporting module 116 may be configured to provide service management (e.g., help desk and technical ticketing) for the endpoints 106. In some embodiments, the incident reporting module 116 may be configured to host one or more webpages or user interface applications that enable the users to interface with the remote management device 104 and/or the admin management device 114.

The incident reporting module 116 may provide an incident workspace, in which new incident reports may be created. For instance, a user of an endpoint 106 may request to create a new incident report following an event. In response to the request from the user, the incident reporting module 116 may create the incident report corresponding to the incident. The incident reporting module 116 may obtain incident data via the user interface applications or the one or more webpages. For example, the user may provide and/or submit the incident data to the incident reporting module 116. In some embodiments, the incident data may include one or more screenshots and/or screen recordings of the incident. For example, the user may capture the incident in entirety and/or in parts (e.g., key parts) and provide such recordings and/or screenshots to the incident reporting module 116. In some embodiments, the incident reporting module 116 may have screen capture features integrated within the incident reporting module 116. For example, the incident reporting module 116 may allow the user to use the screen capture features of the incident reporting module 116 to generate the one or more screenshots and/or screen recordings without having to leave the incident reporting module 116 (e.g., the user interface for the incident reporting module 116) or having to use a third-party service to generate the screenshots and/or recordings. The incident reporting module 116 may automatically format the screenshots and/or the screen recordings to be suitable for further analysis and processing.

In some embodiments, the incident reporting module 116 may analyze the incident data based on the one or more screenshots and/or screen recordings to identify one or more incidental features. In some embodiments, the incidental features may include anomalies or uncommon features in the screenshots and/or screen recordings. In some embodiments, the incidental features may be identified based on texts present in the screenshots and/or screen recordings. For example, optical character recognition (OCR) may be performed on the screenshots and/or screen recordings to identify the texts. In some embodiments, the incident reporting module 116 may include an OCR module or an OCR feature integrated. In other embodiments, the incident reporting module 116 may use a third-party or a remote OCR service.

In some embodiments, the one or more incidental features may be identified from the incident data (e.g., the texts) using an artificial intelligence (AI) model. For example, the AI model may be trained to identify anomalies in the texts that may be related to the incident. In some embodiments, the AI model may be part of the incident reporting module 116. In other embodiments, the AI model may be separate from the incident reporting module 116 but configured to communicate with the incident reporting module 116. In some embodiments, the AI model may include an AI engine. The AI engine may include a large language model (LLM) and/or other AI programs that comprehend the input (e.g., the texts) and identify the one or more incidental features. Some examples of the AI engine may include GPT™ by OpenAI™, Gemini™ by Google™, LLaMA™ by Meta™, and the like. In some embodiments, the incident reporting module 116 may generate a reconstructed incident corresponding to the incident based on the one or more incidental features. The reconstructed incident may be communicated to the diagnostics module 118.

The diagnostics module 118 may be configured to perform diagnostic of the incident based on the reconstructed incident to identify one or more potential causes and one or more potential solutions for the incident. For instance, the one or more potential solutions may be determined from the incidental features and events that follow the incidental features. For example, relationships between the incidental features and events caused by the incidental features may be determined. From such relationships, the diagnostics module 118 may determine one or more potential causes of the incident. For each potential cause, the diagnostic module 118 may determine a potential solution. In some embodiments, the potential solutions may be evaluated. For example, the potential solutions may be applied to the reconstructed incident. The results of applying the potential solutions may be monitored and analyzed to determine whether the incident is resolved.

In some embodiments, the incident reporting module 116 or the diagnostic module 118 may be configured to store information and data related to the incidents in a temporary local cache file. For instance, the incident reporting module 116 or the diagnostic module 118 may store the information and data in an AppData folder and may encrypt the information and data. In circumstances in which multiple incidents are under investigation, multiple cache files may be generated (e.g., one for each incident). The information and data may be accessed and used to reconstruct the incident as described elsewhere in the present disclosure. Following reconstruction, the cache file may be deleted. Use of the cache files may be an efficient process that does not disrupt or slow operations in the operating environment 100.

Additionally, in some embodiments, the incident reporting module 116 or the diagnostic module 118 may use one or more application programming interfaces (APIs) to communicate with one or more components of the operating environment 100. The APIs may be used to retrieve data related to the incident, which may enable the reconstruction.

Modifications, additions, or omissions may be made to the operating environment 100 without departing from the scope of the present disclosure. For example, the operating environment 100 may include one or more managed networks 110, one or more remote management devices 104, one or more endpoints 106, or any combination thereof. Moreover, the separation of various components and devices in the embodiments described herein is not meant to indicate that the separation occurs in all embodiments. Moreover, it may be understood with the benefit of this disclosure that the described components and servers may be integrated together into a single component or server or separated into multiple components or servers.

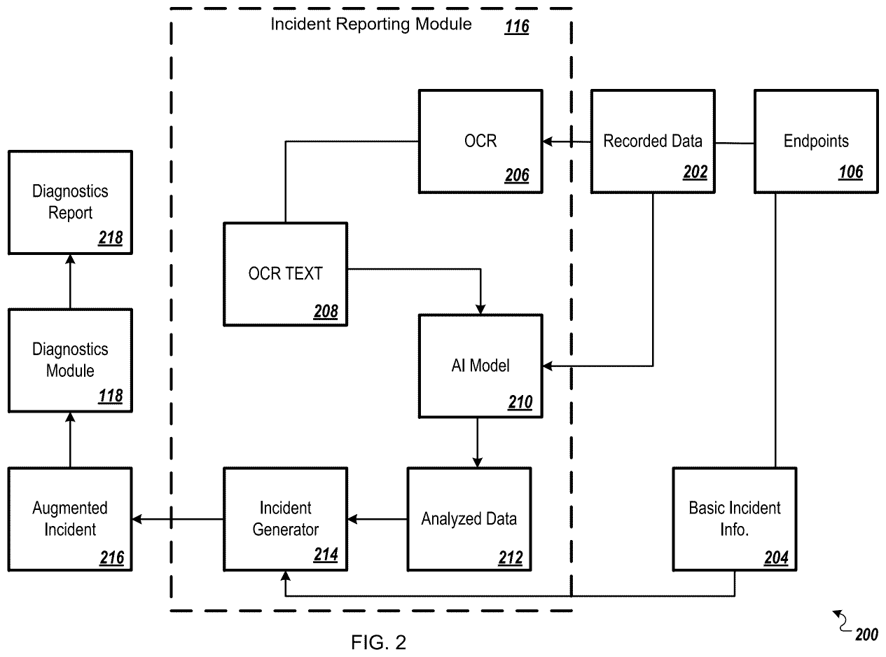

FIG. 2 depicts a block diagram of an example incident reporting and analysis process 200 (process 200) that may be implemented in the operating environment 100 of FIG. 1 or another suitable operating environment. The process 200 may be implemented in the managed network 110. FIG. 2 may include one or more components (e.g., the incident reporting module 116, the endpoints 106, etc.) described with reference to FIG. 1. Although not depicted in FIG. 1, data may be communicated via communication network such as the network 120 of FIG. 1.

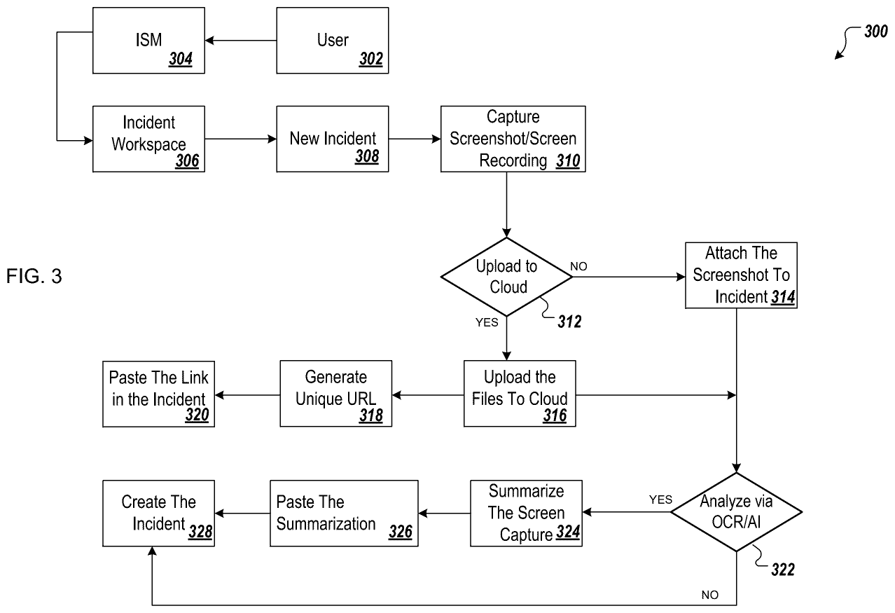

The process 200 may begin with the endpoints 106 or the users of the endpoints 106 providing recorded data 202 and basic incident information 204 to the incident reporting module 116. In some embodiments the recorded data 202 may include one or more screenshots and/or screen recordings of the incident. In some embodiments, the recorded data 202 may be generated using the integrated screen capture feature of the incident reporting module 116. For example, the users of the endpoints 106 may generate the screenshots or recordings using the screen capture feature integrated in the help desk or the incident workspace provided by the incident reporting module 116. In some embodiments, the screen capture feature may visually capture events at a standard frames-per-second (FPS), compress, encode, and save them in a suitable format such as .mp4 format. In some embodiments, the screenshots and/or screen recordings may be stored in a cloud storage and/or stored as attachments to the incident. The storing process may be described in further detail in the present disclosure with respect to FIG. 3.

The basic incident information 204 may include incident information provided by the user such as device information, description of the incident, time and date of the incident, user information, incident title, incident time, initial status, affected user, and/or affected components.

In some embodiments, the incident reporting module 116 may analyze and/or dissect the recorded data 202 using OCR 206. For example, the OCR 206 may determine OCR text 208 from the recorded data 202. The OCR 206 may identify characters from the recorded data 202. The characters or the OCR text 208 may allow the incident reporting module 116 to identify the texts from the incident (e.g., the screenshots and/or screen recordings) instead of merely relying on user's description of the incident.

In some embodiments, an AI model 210 may analyze the OCR text 208 to generate analyzed data 212. The analyzed data 212 may include one or more incidental features identified from the OCR text 208. The incidental features may include abnormal activities or events associated with the incident. Additionally or alternatively, the analyzed data 212 may include summary of the OCR text 208. The AI model 210 may be or include an AI engine that performs such analysis. The analyzed data may further include user device information identified from the OCR text 208 such as device or user identifier information relative to a network, device type and component capabilities, role assignment of a user, policies applicable to the device or user, products sitting on the device and status of products, and/or geographic location. The AI model 210 may include a large language model (LLM) and/or other AI programs that comprehend the input (e.g., the texts) and identify the one or more incidental features. Some examples of the AI engine may include GPT™ by OpenAI™, Gemini™ by Google™, LLaMA™ by Meta™, and the like.

Incident generator 214 may be configured to generate a reconstructed incident or an augmented incident 216 based on the analyzed data 212. The augmented incident 216 may be an augmented version of the incident. For example, the augmented incident 216 duplicates the processes including the incidental features based on the analyzed data 212. For example, the augmented incident 216 may be a simulation of the incident. In some embodiments, the incident generator 214 may also directly obtain the basic incident information 204 such that the augmented incident 216 may be more detailed.

In some embodiments, the diagnostics module 118 may obtain the augmented incident 216. The diagnostics module 118 may perform diagnostics of the incident based on the reconstructed incident to identify one or more potential causes of the incident. For example, the diagnostics module 118 may identify abnormal events and/or features that may cause the incident. Additionally, the diagnostics module 118 may identify and/or determine one or more potential solutions for the incident. In some embodiments, the one or more potential solutions may correspond to the one or more potential causes. For example, for each cause, one or more potential solutions may be determined. In some embodiments, machine learning approach and/or an AI model trained to identify the solutions may be implemented to identify the one or more potential solutions.

The one or more potential solutions may be evaluated using the augmented incident 216. For example, each potential solution may be applied to the augmented incident 216. For instance, the simulation of the incident may be simulated including and/or applying the potential solutions. The resulting simulation of the incident may be evaluated to determine how well each potential solution resolves the incident. In some embodiments, the evaluation may include assigning scores to the potential solutions. The potential solutions may be ranked based on the assigned scores.

In some embodiments, the diagnostics module 118 may be configured to generate a diagnostic report 218. The diagnostic report 218 may include type of incident, possible causes of the incident, possible solutions to the incident, a summary of the incident, and/or the one or both of screenshots and screen recordings. In some embodiments, the diagnostic report 218 may include the scores assigned to the potential solutions. In some embodiments, only the potential solutions with scores above a score threshold may be included in the diagnostic report 218. In some embodiments, the diagnostic module 118 may provide the diagnostic report 218 to the user of the endpoints 106.

Modifications, additions, or omissions may be made to the process 200 without departing from the scope of the present disclosure. For example, the operating environment 100 may include one or more managed networks 110, one or more remote management devices 104, one or more endpoints 106, or any combination thereof. Moreover, the separation of various components and devices in the embodiments described herein is not meant to indicate that the separation occurs in all embodiments. Moreover, it may be understood with the benefit of this disclosure that the described components and servers may be integrated together into a single component or server or separated into multiple components or servers.

FIG. 3 illustrates a flowchart of an example process 300 for incident reporting and management, in accordance with one or more embodiments of the present disclosure. The process 300 may begin with a user 302 initiating communication with an incident service management (ISM) 304. The user 302 may be a user of a managed device or an endpoint such as the endpoints 106 of FIG. 1. In some embodiments, the ISM 304 may correspond to an incident reporting module such as the incident reporting module 116 as illustrated in FIGS. 1 and 2. The user 302 may initiate communication with the ISM 304 to report an incident associated with the user 302 or the endpoint corresponding to the user 302.

The ISM 304 may provide an incident workspace 306, in which the user 302 may submit a request to create a new incident 308. The ISM 304 may create the new incident 308 within the incident workspace 306 based on the request of the user 302. The new incident 308 may correspond to a new ticket or a service request submitted by the user 302.

In some embodiments, the ISM 304 may obtain information associated with the new incident 308 from the user 302. In some embodiments, the information may include screenshots and/or screen recordings of the incident at the endpoint. For example, at block 310, the screenshots and/or screen recordings of the new incident 308 may be captured. In some embodiments, the screenshots and/or the screen recordings may be captured using a screen capture feature integrated in the ISM 304 or the incident workspace 306. In some embodiments, such capturing process may be disclosed in further detail with respect to FIGS. 1 and 2 of the present disclosure.

At block 312, it may be determined whether the capture screenshots and/or screen recordings are uploaded to a cloud storage. In some embodiments, the screenshots and/or the screen recordings may be uploaded to cloud storage like blob storage on service providers like AWS or Azure. For instance, when the user 302 captures the screen, a file is created, and it is uploaded to blob storage through this service. In some embodiments, the user 302 may determine whether to upload the screenshot and/or the screen recordings to the cloud storage. In instances in which the user 302 prefers not to upload to the cloud storage, the screenshots and/or the screen recordings may be attached to the new incident 308 of block 314.

In instances in which the user 302 prefers or does not opt out of uploading to the cloud storage, the files (e.g., the screenshots and/or the screen recordings) may be uploaded to the cloud storage at block 316. In these and other embodiments, default settings may be to upload the files to the cloud storage unless specified otherwise by the user 302.

At block 318, unique uniform resource locators (URLs) for the files uploaded to the cloud storage may be generated. The unique URLs may be a reference or address used to access resources on the internet. The unique URLs may direct to the files uploaded to the cloud storage such that the file may be easily located. In some embodiments, the cloud storage may be configured to automatically generate the unique URLs. In other embodiments, the ISM 304 may cause the cloud storage to generate the unique URLs.

At block 320, the unique URLs may be assigned to the new incident 308. For instance, the unique URLs may be pasted in as part of the description of the new incident 308.

Regardless of whether the files are uploaded to the cloud storage or not, the files may be analyzed using OCR and an AI model at block 322. An example analysis process using the OCR and the AI model is described with respect to the OCR 206 and the AI model 210 of FIG. 2.

In some embodiments, the analysis may include generating a summary of the files at block 324. For example, the AI model may obtain the texts of the files from the OCR and generate a summary of the texts. At block 326, the summary may be attached to the new incident 308 (e.g., pasted into the description of the new incident 308). At block 328, the new incident 308 may be finalized and generated such that the incident is available for further diagnostics, such as by the diagnostics module 118.

In other embodiments, the analysis may not include generating a summary of the texts. In these and other embodiments, the analysis results without the summary may be used to finalize the new incident 308 for further diagnostics.

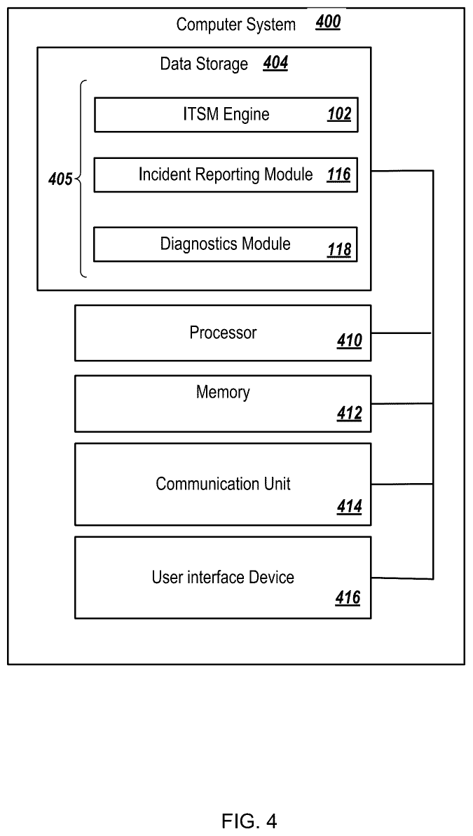

FIG. 4 illustrates an example computer system 400 configured for incident reporting and management according to at least one embodiment of the present disclosure. The computer system 400 may be implemented in the operating environment 100 of FIG. 1, for instance. Examples of the computer system 400 may include the remote management device 104 and the endpoints 106. The computer system 400 may include one or more processors 410, a memory 412, a communication unit 414, a user interface device 416, and a data storage 404 that includes one or more or a combination of the, the ITSM engine 102, the incident reporting module 116, and the diagnostics module 118 (collectively, modules 405).

The processor 410 may include any suitable special-purpose or general-purpose computer, computing entity, or processing device including various computer hardware or software modules and may be configured to execute instructions stored on any applicable computer-readable storage media. For example, the processor 410 may include a microprocessor, a microcontroller, a digital signal processor (DSP), an ASIC, an FPGA, or any other digital or analog circuitry configured to interpret and/or to execute program instructions and/or to process data. Although illustrated as a single processor in FIG. 4, the processor 410 may more generally include any number of processors configured to perform individually or collectively any number of operations described in the present disclosure. Additionally, one or more of the processors 410 may be present on one or more different electronic devices or computing systems. In some embodiments, the processor 410 may interpret and/or execute program instructions and/or process data stored in the memory 412, the data storage 404, or the memory 412 and the data storage 404. In some embodiments, the processor 410 may fetch program instructions from the data storage 404 and load the program instructions in the memory 412. After the program instructions are loaded into the memory 412, the processor 410 may execute the program instructions.

The memory 412 and the data storage 404 may include computer-readable storage media for carrying or having computer-executable instructions or data structures stored thereon. Such computer-readable storage media may include any available media that may be accessed by a general-purpose or special-purpose computer, such as the processor 410. By way of example, and not limitation, such computer-readable storage media may include tangible or non-transitory computer-readable storage media including RAM, ROM, EEPROM, CD-ROM or other optical disk storage, magnetic disk storage or other magnetic storage devices, flash memory devices (e.g., solid state memory devices), or any other storage medium which may be used to carry or store desired program code in the form of computer-executable instructions or data structures and that may be accessed by a general-purpose or special-purpose computer. Combinations of the above may also be included within the scope of computer-readable storage media. Computer-executable instructions may include, for example, instructions and data configured to cause the processor 410 to perform a certain operation or group of operations.

The communication unit 414 may include one or more pieces of hardware configured to receive and send communications. In some embodiments, the communication unit 414 may include one or more of an antenna, a wired port, and modulation/demodulation hardware, among other communication hardware devices. In particular, the communication unit 414 may be configured to receive a communication from outside the computer system 400 and to present the communication to the processor 410 or to send a communication from the processor 410 to another device or network (e.g., the network 120 of FIG. 1).

The user interface device 416 may include one or more pieces of hardware configured to receive input from and/or provide output to a user. In some embodiments, the user interface device 416 may include one or more of a speaker, a microphone, a display, a keyboard, a touch screen, and a holographic projection, among other hardware devices.

The modules 405 may include program instructions stored in the data storage 404. The processor 410 may be configured to load the system modules into the memory 412 and execute the system modules. Alternatively, the processor 410 may execute the system modules line-by-line from the data storage 404 without loading them into the memory 412. When executing the system modules, the processor 410 may be configured to perform one or more processes or operations described elsewhere in this disclosure.

Modifications, additions, or omissions may be made to the computer system 400 without departing from the scope of the present disclosure. For example, in some embodiments, the computer system 400 may not include the user interface device 416. In some embodiments, the different components of the computer system 400 may be physically separate and may be communicatively coupled via any suitable mechanism. For example, the data storage 404 may be part of a storage device that is separate from a device, which includes the processor 410, the memory 412, and the communication unit 414, that is communicatively coupled to the storage device. The embodiments described herein may include the use of a special-purpose or general-purpose computer including various computer hardware or software modules, as discussed in greater detail below.

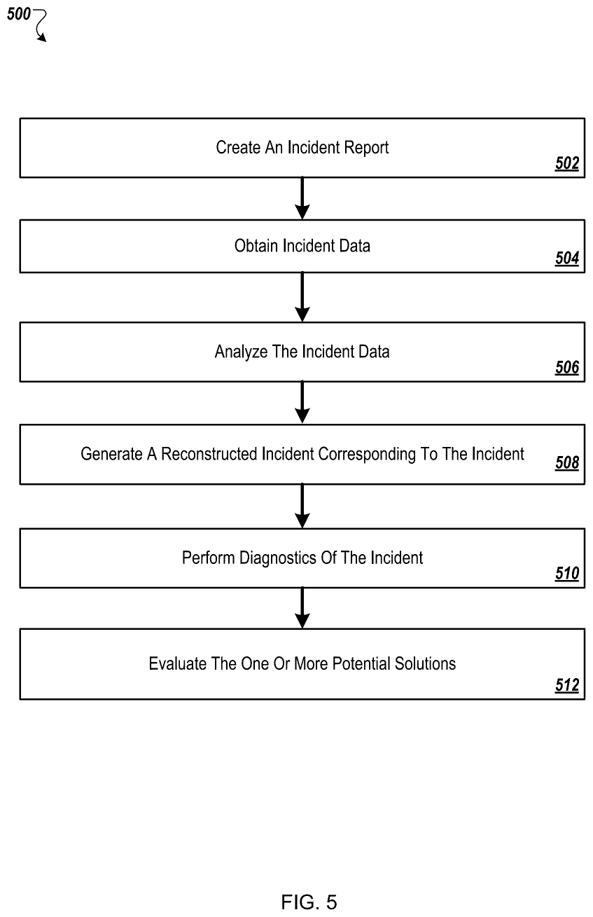

FIG. 5 is a flow chart of an example method 500 of incident reporting and management according to at least one embodiment of the present disclosure. The method 500 may be performed by different modules such as an incident reporting module 116 and a diagnostic module 118 described elsewhere in the present disclosure.

The method 500 may begin at block 502 in which an incident report may be created. The incident report may be created for an incident in an incident workspace. In some embodiments, the incident reporting module may generate the incident workspace. The incident workspace may be a platform and/or a user interface in which users of endpoints or managed devices may report different incidents to ITSM management system.

At block 504, incident data may be obtained. In some embodiments, the incident data may include one or both of screenshots and screen recordings of the incident. The one or both of the screenshots and the screen recordings may be obtained using screen capture feature integrated in the incident workspace. In some embodiments, the obtained screenshots and/or screen recordings may be compressed, encoded, and/or otherwise processed to be in a suitable format, such as .mp4. The integrated screen capture feature may be implemented without the user getting out of the incident workspace or using third-party services. For example, the incident workspace may include a record button that may begin recording contents of the display of the endpoint. The user may run the application or process that is experiencing the issue and/or incident which may be automatically recorded and formatted.

At block 506, the incident data may be analyzed. The incident data may be analyzed based on the one or both of screenshots and screen recordings to identify one or more incidental features. The incidental features may include abnormal activities or events associated with the incident. For example, the incidental features may include an error message, malware detection, configuration change, among others.

In some embodiments, the analysis may include extracting text data from the screenshots and/or the screen recordings using optical character recognition such as the OCR 206 of FIG. 2. The OCR may identify characters from the screenshots and/or the screen recording. The text data may be analyzed to identify the one or more incidental features. In some embodiments, an AI model may be used to identify the one or more incidental features. For example, the AI model may be trained to identify the incidental features from the text data. The AI model may include a large language model (LLM) and/or other AI programs that comprehend the input (e.g., the texts) and identify the one or more incidental features. Some examples of the AI engine may include GPT™ by OpenAI™, Gemini™ by Google™, LLaMA™ by Meta™, and the like. In some embodiments, the AI model may be configured to generate a summary of the text data.

At block 508, a reconstructed incident corresponding to the incident may be generated. The reconstructed incident may be generated based on the one or more incidental features. In some embodiments, the reconstructed incident may be an augmented incident. The augmented incident may be a simulation of the incident. In some embodiments, the reconstructed incident may be generated further based on basic incident information of the incident such as device information, description of the incident, time and date of the incident, user information, incident title, incident time, initial status, affected user, and/or affected components.

At block 510, diagnostics of the incident may be performed. The diagnostics may be based on the reconstructed incident to identify one or more potential causes and one or more solutions for the incident. The diagnostics may identify abnormal events and/or features that may cause the incident. Additionally, the diagnostics may identify and/or determine one or more potential solutions for the incident. In some embodiments, the one or more potential solutions may correspond to the one or more potential causes. For example, for each cause, one or more potential solutions may be determined. In some embodiments, machine learning approach and/or an AI model trained to identify the solutions may be implemented to identify the one or more potential solutions.

At block 512, the one or more potential solutions may be evaluated. For example, each potential solution may be applied to the reconstructed incident. For instance, the simulation of the incident may be revised to be simulated including and/or applying the potential solutions. The resulting simulation of the incident may be evaluated to determine how well each potential solution resolves the incident. In some embodiments, the evaluation may include assigning scores to the potential solutions. The potential solutions may be ranked based on the assigned scores.

In some embodiments, a diagnostic report may be generated. The diagnostic report may include type of incident, possible causes of the incident, possible solutions to the incident, a summary of the incident, and/or the one or both of screenshots and screen recordings. In some embodiments, the diagnostic report may include the scores assigned to the potential solutions. In some embodiments, only the potential solutions with scores above a score threshold may be included in the diagnostic report.

The method 500 may be performed by the remote management device 104 described elsewhere in the present disclosure or by another suitable computing system, such as the computer system 400 of FIG. 4. In some embodiments, the remote management device 104 or the other computing system may include or may be communicatively coupled to a non-transitory computer-readable medium (e.g., the memory 412 of FIG. 4) having stored thereon programming code or instructions that are executable by one or more processors (such as the processor 410 of FIG. 4) to cause a computing system or the remote management device 104 to perform or control performance of the method 500. Additionally or alternatively, the remote management device 104 may include the processor 410 that is configured to execute computer instructions to cause the remote management device 104 or other computing systems to perform or control performance of the method 500. The remote management device 104 or the computer system 400 implementing the method 500 may be included in a cloud-based managed network, an on-premises system, or another suitable network computing environment. Although illustrated as discrete blocks, one or more blocks in FIG. 5 may be divided into additional blocks, combined into fewer blocks, or eliminated, depending on the desired implementation.

For example, the method 500 may further include storing the one or more screenshots and/or the screen recordings in a cloud-based storage like blob storage on service providers like AWS or Azure. For instance, when the user captures the screen, a file including the captured screen (e.g., the screenshots and/or the screen recordings) is created, and the file uploaded to blob storage through this service. In some embodiments, the user generating the screen captures may determine whether to upload the screenshot and/or the screen recordings to the cloud storage. In instances in which the user prefers not to upload to the cloud storage, the screenshots and/or the screen recordings may be attached (e.g., as file attachments as part of the incident) to the new incident.

In some embodiments, a unique URL corresponding to the one or both of screenshots and screen recordings may be generated. The unique URLs may be references or addresses used to access resources on the internet. The unique URLs may direct to the files uploaded to the cloud storage such that the file may be easily located. In some embodiments, the cloud storage may be configured to automatically generate the unique URLs. The URLs may be associated with the incident. For example, the URLs may be inserted and/or pasted as part of the description of the incident in the incident workspace. Such association may allow a quick reference to related files (e.g., the screen captures), without storing all files locally or on the server.

The embodiments described herein may include the use of a special purpose or general-purpose computer including various computer hardware or software modules, as discussed in greater detail below.

Embodiments described herein may be implemented using computer-readable media for carrying or having computer-executable instructions or data structures stored thereon. Such computer-readable media may be any available media that may be accessed by a general purpose or special purpose computer. By way of example, and not limitation, such computer-readable media may include non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to carry or store desired program code in the form of computer-executable instructions or data structures and which may be accessed by a general purpose or special purpose computer. Combinations of the above may also be included within the scope of computer-readable media.

Computer-executable instructions may include, for example, instructions and data, which cause a general-purpose computer, special purpose computer, or special purpose processing device (e.g., one or more processors) to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the terms “module” or “component” may refer to specific hardware implementations configured to perform the operations of the module or component and/or software objects or software routines that may be stored on and/or executed by general purpose hardware (e.g., computer-readable media, processing devices, etc.) of the computing system. In some embodiments, the different components, modules, engines, and services described herein may be implemented as objects or processes that execute on the computing system (e.g., as separate threads). While some of the system and methods described herein are generally described as being implemented in software (stored on and/or executed by general purpose hardware), specific hardware implementations or a combination of software and specific hardware implementations are also possible and contemplated. In this description, a “computing entity” may be any computing system as previously defined herein, or any module or combination of modulates running on a computing system.

The various features illustrated in the drawings may not be drawn to scale. The illustrations presented in the present disclosure are not meant to be actual views of any particular apparatus (e.g., device, system, etc.) or method, but are representations employed to describe embodiments of the disclosure. Accordingly, the dimensions of the features may be expanded or reduced for clarity. In addition, some of the drawings may be simplified for clarity. Thus, the drawings may not depict all of the components of a given apparatus (e.g., device) or all operations of a particular method.

Terms used in the present disclosure and the claims (e.g., bodies of the appended claims) are intended as “open” terms (e.g., the term “including” should be interpreted as “including, but not limited to,” the term “having” should be interpreted as “having at least,” the term “includes” should be interpreted as “includes, but is not limited to,” among others). Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in instances in which a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Further, any disjunctive word or phrase presenting two or more alternative terms should be understood to contemplate the possibilities of including one of the terms, either of the terms, or both terms. For example, the phrase “A or B” should be understood to include the possibilities of “A” or “B” or “A and B.”

However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

The terms “first,” “second,” “third,” etc., are not necessarily used to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms “first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present inventions have been described in detail, it should be understood that the various changes, substitutions, and alterations could be made hereto without departing from the scope of the invention.

What is claimed is:

1. A method of incident analysis, the method comprising:
creating an incident report for an incident in an incident workspace;
obtaining incident data including one or both of screenshots and screen recordings of the incident, the one or both of screenshots and screen recordings obtained using screen capture feature integrated in the incident workspace;
analyzing the incident data based on the one or both of screenshots and screen recordings to identify one or more incidental features;
generating a reconstructed incident corresponding to the incident based on the one or more incidental features;
performing diagnostics of the incident based on the reconstructed incident to identify one or more potential causes and one or more potential solutions for the incident; and
evaluating the one or more potential solutions.

2. The method of claim 1, wherein analyzing the incident data based on the screenshots comprises:
extracting text data from the screenshots using optical character recognition (OCR); and
analyzing the text data and the one or both of screenshots and screen recordings using an artificial intelligence (AI) model.

3. The method of claim 2, wherein the AI model generates a summary of the text data.

4. The method of claim 3, wherein the AI model is a large language model (LLM).

5. The method of claim 3, wherein the AI model captures user device information from the text data, the user device information including one or more or a combination of:
device or user identifier information relative to a network,
device type and component capabilities,
role assignment of a user,
policies applicable to the device or user,
products sitting on the device and status of products, and
geographic location.

6. The method of claim 1, wherein the incidental features include abnormal activities or events associated with the incident.

7. The method of claim 1, further comprising:
generating a summary of the incident report, the summary including one or more or a combination of:
a type of incident,
a possible cause of the incident,
a possible solution to the incident,
a summary of the incident,
the screenshots, and
the screen recordings.

8. The method of claim 1, further comprising:
storing the one or both of screenshots and screen recordings in a cloud-based storage;
generating a unique uniform resource locator (URL) corresponding to the one or both of screenshots and screen recordings; and
associating the URL with the incident.

9. The method of claim 1, wherein the incident data is obtained from a user through a user interface (UI).

10. The method of claim 1, wherein the incident data further includes basic incident information provided by a user, including one or more or a combination of: an incident title, an incident time, an initial status, an affected user, and an affected component.

11. The method of claim 1, wherein the reconstructed incident includes an augmented incident.

12. A non-transitory computer-readable medium having encoded therein programming code executable by one or more processors to perform or control performance of operations of incident analysis, the operations comprising:
creating an incident report for an incident in an incident workspace;
obtaining incident data including one or both of screenshots and screen recordings of the incident, the one or both of screenshots and screen recordings obtained using screen capture feature integrated in the incident workspace;
analyzing the incident data based on the one or both of screenshots and screen recordings to identify one or more incidental features;
generating a reconstructed incident corresponding to the incident based on the one or more incidental features;
performing diagnostics of the incident based on the reconstructed incident to identify one or more potential causes and one or more potential solutions for the incident; and
evaluating the one or more potential solutions.

13. The non-transitory computer-readable medium of claim 12, wherein analyzing the incident data based on the screenshots comprises:
extracting text data from the screenshots using optical character recognition (OCR); and
analyzing the text data and the one or both of screenshots and screen recordings using an artificial intelligence (AI) model.

14. The non-transitory computer-readable medium of claim 13, wherein:
the AI model generates a summary of the text data;
the AI model is a large language model (LLM);
the incidental features include abnormal activities or events associated with the incident; and
the incident data is obtained from a user through a user interface (UI).

15. The non-transitory computer-readable medium of claim 14, wherein:
the AI model captures user device information from the text data;
the user device information includes one or more or a combination of:
device or user identifier information relative to a network;
device type and component capabilities;
role assignment of a user;
policies applicable to the device or user;
products sitting on the device and status of products; and
geographic location.

16. The non-transitory computer-readable medium of claim 12, wherein the incidental features include abnormal activities or events associated with the incident.

17. The non-transitory computer-readable medium of claim 12, wherein:
the operations further comprise generating a summary of the incident report; and
the summary includes one or more or a combination of:
a type of incident;
a possible cause of the incident;
a possible solution to the incident;
a summary of the incident;
the screenshots; and
the screen recordings.

18. The non-transitory computer-readable medium of claim 12, wherein the operations further comprises:
storing the one or both of screenshots and screen recordings in a cloud-based storage;
generating a unique uniform resource locator (URL) corresponding to the one or both of screenshots and screen recordings; and
associating the URL with the incident.

19. The non-transitory computer-readable medium of claim 12, wherein:
the incident data further includes basic incident information provided by a user; and
the basic incident information includes one or more or a combination of:
an incident title;
an incident time;
an initial status;
an affected user; and
an affected component.

20. The non-transitory computer-readable medium of claim 12, wherein the reconstructed incident includes an augmented incident.
